(19) United States
(12) Patent Application Publication
(10) Pub. No.: US 2006/0152648 A1
(43) Pub. Date: Jul. 13, 2006

(54) Display device and portable display apparatus including the same

(75) Inventors: Sung-min Kim, Yongin-si (KR); Byung-woong Han, Incheon Metropolitan City (KR); Young-bee Chu, Suwon-si (KR); Jeung-soo Kim, Seoul (KR); Jong-nam Lee, Anyang-si (KR); Kyu-seok Kim, Yongin-si (KR); Sang-hee Lee, Yongin-si (KR); Dong-cheol Kim, Suwon-si (KR); Young-hee Park, Busan Metropolitan City (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/329,720

(22) Filed: Jan. 11, 2006

(30) Foreign Application Priority Data
Jan. 12, 2005 (KR) 10-2005-0002975
May 26, 2005 (KR) 10-2005-0044616

(51) Int. Cl. G02F 1/1333

(52) U.S. Cl. 349/58

(57) ABSTRACT

A display device is provided. The display device comprises a display panel. The display device further comprises a transparent film disposed on the display panel and a buffer layer having an adhesive characteristic interposed between the transparent film and the second plate.

This application claims priority from Korean Patent Application Nos. Korean Patent Application Nos. 10-2005-0002975 and 10-2005-0044616 filed on Jan. 12, 2005 and May 26, 2005 respectively in the Korean Intellectual Property Office, the disclosures of which are incorporated by reference herein in their entireties.

### BACKGROUND OF THE INVENTION

1. Field of the Invention

The present invention relates to a display device and a portable display apparatus including the same. More particularly, the present invention relates to a thin, lightweight liquid crystal display and a portable display apparatus including the same.

2. Description of the Related Art

Generally, liquid crystal displays are completed by attaching an integrated circuit (IC) driver to a liquid crystal panel composed of a first plate including a thin film transistor array, a second plate including a color filter layer, and liquid crystals interposed between the two substrates.

Liquid crystal displays may be used in a wide variety of applications such as, for monitors of image display devices (e.g., mobile phones, notebook computers, and personal digital assistants (PDAs), or the like).

To apply a liquid crystal display to a portable display apparatus, the liquid crystal display is typically first contained in a predetermined frame structure. The resultant frame structure is housed in a case having an image display window so that an image display surface of the liquid crystal display is exposed through the window. The image display surface exposed through the window of the case is then covered and protected with a protection window made of, for example, transparent glass.

However, there are certain difficulties encountered when using conventional liquid crystal displays. For example, the protection window is separated from the liquid crystal display by a predetermined distance and made of a glass or plastic material, thereby resulting in the liquid crystal display occupying a significant proportion of the thickness and weight of a portable display apparatus. In addition, conventional liquid crystal displays are also very susceptible to being damaged due to external shock.

Accordingly, there is a need for a liquid crystal display which is thin, lightweight, and resistant to external shock.

### SUMMARY OF THE INVENTION

According to an exemplary embodiment of the present invention, a display device is provided. The display device comprises a display panel. The display device further comprises a transparent film disposed on the display panel and a buffer layer interposed between the transparent film and the display panel for protecting display panel from external shock, scratch, and/or chemicals. It is desirable that the buffer layer has an adhesive characteristic so as to adhere the transparent film to the display panel. It is also desirable that the buffer layer has a light transmittance of at least about 90%. It is also desirable that the buffer layer has a multi-layered structure including a first adhesive layer, a second adhesive layer and a cushion layer interposed between the first adhesive layer and the second adhesive layer.

According to another exemplary embodiment of the present invention, a liquid crystal display is provided. The liquid crystal display comprises a liquid crystal panel including a first plate, a second plate disposed on the first plate, and a liquid crystal layer interposed between the first plate and the second plate. The liquid crystal display further comprises a transparent film disposed on an upper surface of the second plate and a buffer layer interposed between the transparent film and the second plate for protecting the liquid crystal panel from an external shock, scratch, and/or chemicals. It is desirable that the buffer layer has an adhesive characteristic so as to adhere the transparent film to the second plate of the liquid crystal panel. It is also desirable that the buffer layer has a light transmittance of at least about 90%. It is also desirable that the buffer layer has a multi-layered structure including a first adhesive layer, a second adhesive layer and a cushion layer interposed between the first adhesive layer and the second adhesive layer.

According to another exemplary embodiment of the present invention, a liquid crystal display is provided. The liquid crystal display includes a liquid crystal panel module including first and second liquid crystal panels each having a first plate, a second plate and a liquid crystal layer interposed between the first plate and the second plate. The first plates of the first and second liquid crystal panels are opposite to each other. Moreover, the liquid crystal display further includes transparent films disposed on upper surfaces of the second plates of the first and second liquid crystal panels of the liquid crystal panel module and buffer layers interposed between the transparent films and the second plates of the first and second liquid crystal panels for protecting the liquid crystal panel module from an external shock, scratch, and/or chemicals. It is desirable that the buffer layers have an adhesive characteristic so as to adhere the transparent films to the second plates of the first and second liquid crystal panels of the liquid crystal panel module. It is also desirable that the buffer layer has a light transmittance of at least about 90%. It is also desirable that the buffer layer has a multi-layered structure including a first adhesive layer, a second adhesive layer and a cushion layer interposed between the first adhesive layer and the second adhesive layer.

According to still another exemplary embodiment of the present invention, a portable display apparatus is provided. The portable display apparatus includes a liquid crystal display including liquid crystal panel having a first plate, a second plate disposed on the first plate, and a liquid crystal layer interposed between the first plate and the second plate. The portable display apparatus further includes a transparent film disposed on an upper surface of the second plate, and a buffer layer interposed between the transparent film and the second plate for protecting the liquid crystal panel from an external shock, scratch, and/or chemicals. It is desirable that the buffer layer has an adhesive characteristic so as to adhere the transparent film to the second plate of the liquid crystal panel. Moreover, the portable display apparatus further includes a frame for mounting and supporting the liquid crystal display, and a case for housing the frame. It is also desirable that the buffer layer has a light transmittance of at least about 90%. It is also desirable that the buffer layer has a multi-layered structure including a first adhesive layer, a second adhesive layer and a cushion layer interposed between the first adhesive layer and the second adhesive layer.

According to another exemplary embodiment of the present invention, a portable display apparatus is provided. The portable display apparatus includes a liquid crystal display which includes a liquid crystal panel module including first and second liquid crystal panels each having a first plate, a second plate and a liquid crystal layer interposed between the first plate and the second plate, with the first plates of the first and second liquid crystal panels being opposite to each other. The portable display apparatus further includes transparent films disposed on upper surfaces of the second plates of the first and second liquid crystal panels of the liquid crystal panel module, and buffer layers interposed between the transparent films and the second plates of the first and second liquid crystal panels for protecting the liquid crystal panel module from an external shock, scratch, and/or chemicals. It is desirable that the buffer layers have an adhesive characteristic so as to adhere the transparent films to the second plates of the first and second liquid crystal panels of the liquid crystal panel module. In addition, the portable display apparatus further includes a frame for mounting and supporting the liquid crystal display, and a case for housing the frame. It is also desirable that the buffer layer has a light transmittance of at least about 90%. It is also desirable that the buffer layer has a multi-layered structure including which has a first adhesive layer, a second adhesive layer and a cushion layer interposed between the first adhesive layer and the second adhesive layer.

### BRIEF DESCRIPTION OF THE DRAWINGS

FIGS. 1a through 4 are partial sectional views of liquid crystal displays according to an exemplary embodiment of the present invention;

FIG. 5 is a perspective view of a portable display apparatus according to an exemplary embodiment of the present invention;

FIG. 6 is a longitudinal sectional view of a portion A of FIG. 5;

FIG. 7 is a perspective view of a portable display apparatus according to another exemplary embodiment of the present invention; and

FIG. 8 is a longitudinal sectional view of a portion B of FIG. 7.

### DETAILED DESCRIPTION OF THE EXEMPLARY EMBODIMENTS OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Like reference numerals refer to like elements throughout the specification.

A Display device according to embodiments of the present invention will now be described. The display device according to the embodiments comprises a display panel, a transparent film disposed on the display panel, and a buffer layer interposed between the transparent film and the display panel. A liquid crystal display will be exemplified as the display device hereinafter. The present invention however is not limited thereto and could apply to a variety of display devices available to display an image. In the liquid crystal display, the display panel is the liquid crystal panel.

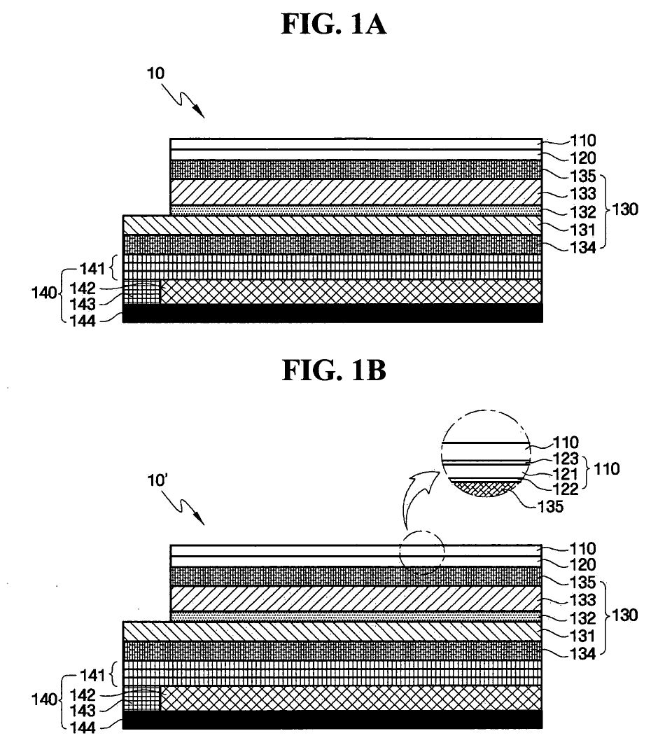

FIGS. 1a and 1b are a partial sectional views of a liquid crystal display 10 and 10′ according to an exemplary embodiment of the present invention, in which various layers are not illustrated as real sizes and should not be taken to be limiting of the invention.

Referring to FIGS. 1a and 1b, the liquid crystal display 10 includes a transparent film 110, a buffer layer 120, a liquid crystal panel 130, and a backlight unit 140.

In this exemplary embodiment, when installing the constitutional elements of the liquid crystal display, including those mentioned above in an image display apparatus (e.g., a portable display device or an LCD monitor) they are mounted and supported in a plurality of frames, including a mold frame, a metal frame, and so on, and then housed in an outer case.

The transparent film 110 is used for protecting the liquid crystal panel 130 from external scratches and/or chemicals and thus the transparent film 110 should be made of a material having a resistance to external scratches and chemicals. Furthermore, the transparent film 110 has a light transmittance of about 60% or more. It is desirable that the transparent film 110 has a light transmittance of at least about 90% to allow an image created by the liquid crystal panel 130 to be viewed from the outside. In this exemplary embodiment, the transparent film 110 is formed as a polymer film satisfying the above requirements. For example, in this exemplary embodiment, the polymer film is made of polyethylene terephthalate (PET), polycarbonate (PC), or polymethyl methacrylate (PMMA). The thickness of the transparent film 110 ranges from about 0.2 to about 0.8 cm, but is not limited thereto. The buffer layer 120 is disposed on a lower surface of the transparent film 110 to protect the liquid crystal panel 130 from an external shock. The buffer layer 120 is made of an adhesive material so as to adhere the transparent film 110 to a surface of the liquid crystal panel 130. The buffer layer 120 has one layered structure which has both adhesive characteristic and shock absorbing characteristic in one layer shown by FIG. 1a. The buffer layer 120 has a multi-layered structure which includes each adhesive characteristic and shock absorbing characteristic in each layer consisting multilayer shown by FIG. 1b. The buffer layer 120 includes at least two layers having different characteristics, for example an adhesive layer having the adhesive characteristic and a cushion layer having the shock absorbing characteristic. The buffer layer 120 preferably has the multi-layered structure including a first adhesive layer 122 adhering to the transparent film 110, a second adhesive layer 123 adhering to the liquid crystal panel 130, and a cushion layer 121 interposed between the first adhesive layer 122 and the second adhesive layer 123.

To securely adhere the transparent film 110 to the liquid crystal panel 130, the buffer layer 120 should be made of a material having a good adhesive properties relative to both the transparent film 110 and the liquid crystal panel 130. Furthermore, buffer layer 120 has a light transmittance of about 60% or more. It is desirable that the buffer layer 120 has a light transmittance of at least about 90% to allow an image created by the liquid crystal panel 130 to be viewed from the outside.

In view of the shock absorbing capability of the buffer layer 120, the buffer layer should be made of a material of which hardness is not significantly affected by temperature change. Otherwise, if the buffer layer 120 is made of a material having high hardness at low temperature, it may be easily damaged due to an external shock, which makes it difficult to use the buffer layer 120 as a buffer.

For instance, materials satisfying all the above requirements for forming the buffer layer 120 include but are not limited to a silicone resin or an acrylic resin. For example, the silicone resin may be OPT001-60 (Gel Tec, Inc., Japan) and the acrylic resin may be CLEAR FIT (Mitsubishi, Japan) or OCA (Optical Clear Adhesive) (3M, Corp., Korea). The thickness of the buffer layer 120 preferably ranges from about 0.1 to about 0.5 cm, but is not limited thereto. As described above, when the buffer layer 120 has both an adhesive function and a shock absorbing function, it is more desirable for being used in the manufacturing of a thin liquid crystal display.

The liquid crystal panel 130 is disposed on a lower surface of the buffer layer 120, and includes a first plate 131, a liquid crystal layer 132, a second plate 133, a first polarization plate 134, and a second polarization plate 135.

The first plate 131 is a glass substrate on which a thin film transistor array and pixel electrodes are arranged. Here, the thin film transistor array is used as a switching device for applying a voltage to the pixel electrodes. The second plate 133 is a glass substrate including a color filter layer for red (R), green (G), and blue (B) color emissions. A common electrode is disposed on the entire surface of the second plate 133 having the color filter layer thereon. The common electrode in this exemplary embodiment serves as one electrode applying a voltage to the liquid crystals, and, together with the pixel electrodes of the first plate 131, also generates an electric field.

When the liquid crystal layer 132 is interposed between the first plate 131 and the second plate 133, the basic configuration of the liquid crystal display 10 is completed. The first and second polarization plates 134 and 135 are attached to the respective outermost sides of the first and second plates 131 and 133 to polarize visible light.

The backlight unit 140 is disposed on a lower surface of the liquid crystal panel 130 to provide light to the liquid crystal panel 130, and includes an optical sheet 141, a light guide plate 142, a light source 143, and a reflective sheet 144.

The optical sheet 141 is disposed on a lower surface of the liquid crystal panel 130, and includes a prism sheet and a diffusion sheet. The diffusion sheet is disposed on a light-emitting surface of the light guide plate 142, and it diffuses or scatters light that has passed through the light guide plate 142 and increases and uniformly distributes brightness in the front direction of the light-emitting surface of the backlight unit 140. The prism sheet has a groove surface structure, and concentrates light emitted from the diffusion sheet in the front direction of the light-emitting surface of the backlight unit 140 to enhance the directionality of the light emitted, resulting in an increase in brightness in the front direction of the light-emitting surface of the backlight unit 140. Generally, the backlight unit 140 includes two prism sheets, i.e., vertical and horizontal types.

The light guide plate 142 serves to convert a linear light beam emitted from the light source 143 to a surface light beam. For example, the light guide plate 142 may be made of an acrylic resin such as PMMA. The light guide plate 142 is mainly used in a backlight unit (e.g., the backlight unit 140) for a liquid crystal display using a linear light source such as a fluorescent lamp and any other types of light guide plates may also be used.

The light source 143 is a device generating and emitting light, e.g., an electric bulb, a LED (Light Emitting Diode), an electroluminescent (EL) device, a fluorescent lamp, or a metal halide lamp. The light source 143 may be an edge-type or a direct-type light source depending upon the position of the light source 143, and can also be used in diverse manners depending upon the applications for the liquid crystal display.

The reflective sheet 144 is disposed on a lower surface of the light guide plate l42, and reflects light emitted from the light source 143 toward the light-emitting surface of the backlight unit 140 to increase light utilization efficiency. Also, the reflective sheet 144 adjusts the total reflection amount of incident light beams so that a uniform brightness distribution is achieved on the light-emitting surface of the light source 143.

In the liquid crystal displays according to the above-described exemplary embodiment shown in FIGS. 1A and 1B, since a transparent film is adhered to a liquid crystal panel creating an image by means of a buffer layer having an adhesive characteristic interposed therebetween, the liquid crystal panel is protected from external scratches or shocks. Unlike with conventional liquid crystal displays in which a protection window made of glass or the like is separated from a liquid crystal panel so that the liquid crystal display is susceptible to damages due to an external shock and the overall thickness and weight of the LCD increases, the liquid crystal displays of the exemplary embodiments of the present invention provide thin, lightweight liquid crystal displays by using a transparent film, which is lightweight and resistant to an external shock, and a multi-functional buffer layer.

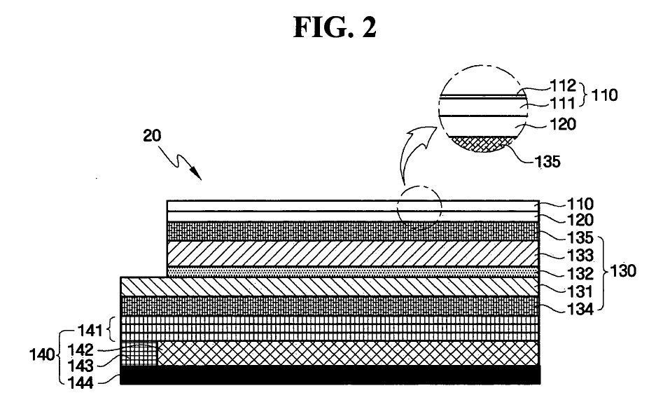

FIG. 2 is a partial sectional view of a liquid crystal display 20 according to another exemplary embodiment of the present invention, in which various layers are not illustrated as real sizes and should not be taken to be limiting of the invention.

The liquid crystal display 20 of the present exemplary embodiment has the same structure as the liquid crystal display 10 and 10′ of the exemplary embodiment shown in FIGS. 1A and 1B except that a transparent film 110 includes a hard coating layer 112, in addition to a polymer film 111. Thus, for convenience of illustration, a detailed description of repeated portions will be omitted.

Referring to FIG. 2, the transparent film 110 of the liquid crystal display 20 is used to protect a liquid crystal panel 130 from external scratches and chemicals. Thus, the transparent film 110 should be made of a material having a resistance to external scratches and chemicals. Furthermore, the transparent film 110 has a light transmittance of about 60% or more. It is desirable that the transparent film 110 has a light transmittance of at least about 90% or more to allow an image created by the liquid crystal panel 130 to be viewed from the outside. Thus, to satisfy the above requirements, in this exemplary embodiment, the transparent film 110 includes the polymer film 111 and the hard coating layer 112 disposed on the polymer film 111. For example, in this exemplary embodiment, the polymer film 111 is made of PET, PC, or PMMA, and the hard coating layer 112 includes a photoresist resin, e.g., a UV-sensitive resin. In addition, it is desirable that the hard coating layer 112 has the pencil hardness of 3 to 4H.

As described above, in the liquid crystal display 20 of this exemplary embodiment, the transparent film 110 disposed on the liquid crystal panel 130 includes the polymer film 111 and the hard coating layer 112, and thus, has a better resistance to scratches and chemicals than a transparent film composed of only a polymer film. Therefore, the liquid crystal display 20 including the hard coating layer 112 effectively protects the liquid crystal panel 130 from external scratches or chemicals.

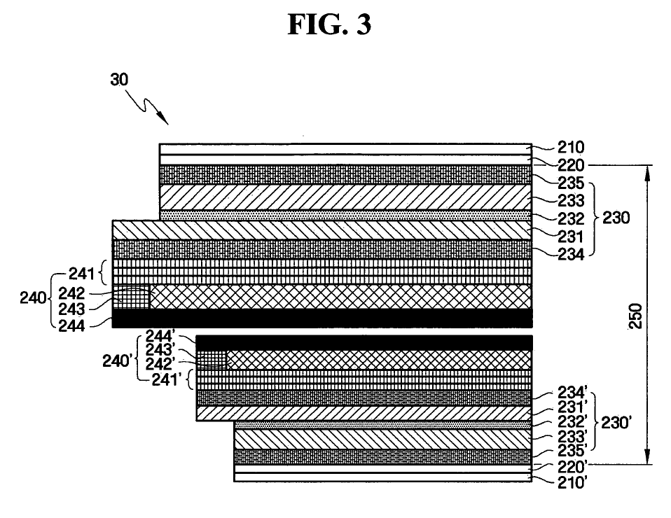

FIG. 3 is a partial sectional view of a liquid crystal display 30 according to still another exemplary embodiment of the present invention, in which various layers are not illustrated as real sizes and should not be taken to be limiting of the invention.

The liquid crystal display 30 of this exemplary embodiment has the same structure as the liquid crystal display 10 and 10′ of the exemplary embodiment shown in FIGS. 1A and 1B except that it further includes a second liquid crystal panel 230′. For sake of clarity and convenience, a detailed description of repeated portions will be omitted.

Referring to FIG. 3, the liquid crystal display 30 includes a first liquid crystal panel 230, a first backlight unit 240, the second liquid crystal panel 230′, and a second backlight unit 240′.

The first liquid crystal panel 230 includes a first plate 231 including a thin film transistor array, and a second plate 233 including a color filter layer and being coupled with the first plate 231 by means of a liquid crystal layer 232 interposed therebetween. First and second polarization plates 234 and 235 are disposed on the outermost surfaces of the first liquid crystal panel 230.

Next, the first backlight unit 240 is disposed on a lower surface of the first plate 231. The first backlight unit 240 includes an optical sheet 241, a light guide plate 242, a lamp 243, and a reflective sheet 244. Similarly to the first liquid crystal panel 230, the second liquid crystal panel 230′ includes a first plate 231′ including a thin film transistor array, and a second plate 233′ including a color filter layer and being coupled with the first plate 231′ by means of a liquid crystal layer 232′ interposed therebetween. First and second polarization plates 234′ and 235′ are disposed on the outermost surfaces of the second liquid crystal panel 230′.

Next, the second backlight unit 240′ is disposed on an upper surface of the first plate 231′. The second backlight unit 240′ includes an optical sheet 241′, a light guide plate 242′, a lamp 243′, and a reflective sheet 244′. In a liquid crystal panel module 250, the first plate 231 of the first liquid crystal panel 230 is opposite to the first plate 231′ of the second liquid crystal panel 230′. That is, opposite surfaces to image display surfaces of the first and second liquid crystal panels 230 and 230′ face each other so that images are created on both surfaces of the liquid crystal panel module 250.

Transparent films 210 and 210′ for protecting the first and second liquid crystal panels 230 and 230′ are respectively disposed on the surfaces of the second plate 233 and the second plate 233′ of the liquid crystal panel module 250 including the first and second liquid crystal panels 230 and 230′. buffer layers 220 and 220′ having an adhesive characteristic are respectively disposed on the surfaces of the transparent film 210 and the transparent film 210′ to adhere the second plates 233 and 233′ of the first and second liquid crystal panels 230 and 230′ to the transparent films 210 and 210′ and to reduce an external shock.

As described above, in the liquid crystal display 30 of this embodiment, the liquid crystal panels 230 and 230′ are protected by attaching the transparent films 210 and 210′, which are lightweight and resistant to an external shock, to the liquid crystal panels 230 and 230′ by means of the buffer layers 220 and 220′ having an adhesive function.

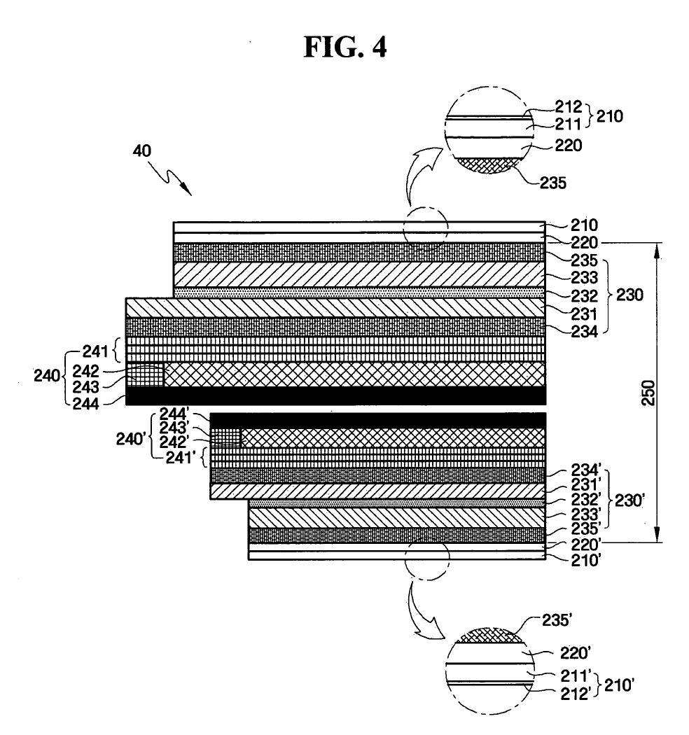

FIG. 4 is a sectional view of a liquid crystal display 40 according to yet another exemplary embodiment of the present invention, in which various layers are not illustrated as real sizes and should not be taken to be limiting of the invention.

The liquid crystal display 40 of the present exemplary embodiment has the same structure as the liquid crystal display 30 of the exemplary embodiment shown in FIG. 3 except that transparent films 210 and 210′ include hard coating layers 212 and 212′, in addition to polymer films 211 and 211′. Thus, for convenience of illustration, a detailed description of repeated portions will be omitted.

Referring to FIG. 4, the transparent films 210 and 210′ of the liquid crystal display 40 are used to protect first and second liquid crystal panels 230 and 230′ from external scratches and chemicals. Thus, the transparent films 210 and 210′ should be made of a material having a resistance to external scratches and chemicals. Furthermore, the transparent films 210 and 210′ have a light transmittance of about 60% or more. It is desirable that the transparent films 210 and 210′ have a light transmittance of at least about 90% or more to allow images created by the first and second liquid crystal panels 230 and 230′ to be viewed from the outside. Thus, the transparent films 210 and 210′ respectively have sequentially stacked structures of the polymer films 211 and 211′ and the hard coating layers 212 and 212′ satisfying the above requirements, and are respectively disposed on second plates 233 and 233′ of the first and second liquid crystal panels 230 and 230′ of a liquid crystal panel module 250.

As described above, in the liquid crystal display 40 of this exemplary embodiment, the transparent films 210 and 210′ disposed on the first and second liquid crystal panels 230 and 230′ include the hard coating layers 212 and 212′, in addition to the polymer films 211 and 211′. Therefore, the first and second liquid crystal panels 230 and 230′ are effectively protected from external scratches or chemicals.

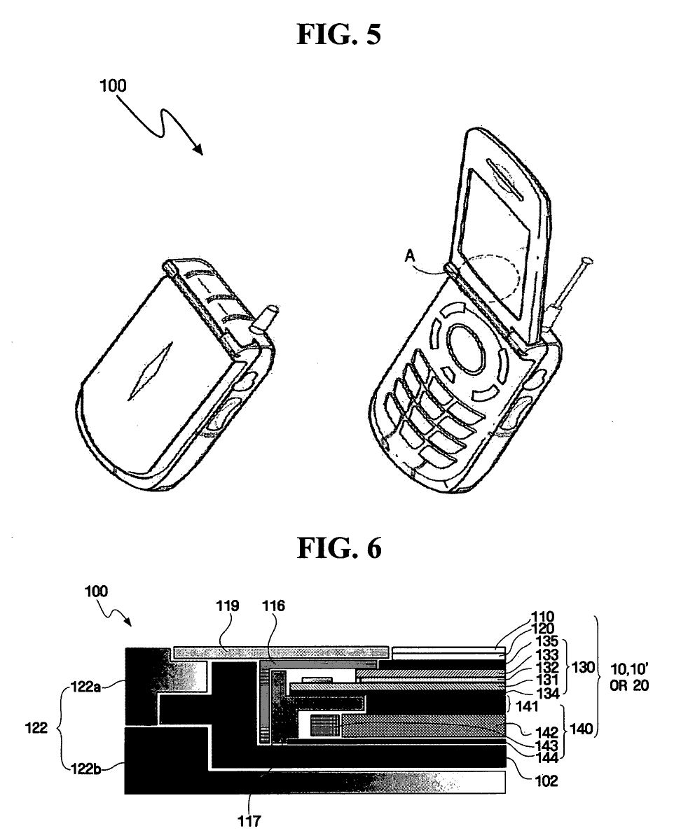

FIG. 5 is a perspective view of a portable display apparatus according to an exemplary embodiment of the present invention and FIG. 6 is a longitudinal sectional view of a portion A of FIG. 6.

Referring to FIG. 5, a portable display apparatus 100 is a folder-type portable display apparatus. The left view of FIG. 5 illustrates a state in which the folder-type portable display apparatus 100 is closed, and the right view of FIG. 5 illustrates a state in which the folder-type portable display apparatus 100 is open. Although the portable display apparatus 100 is illustrated as a folder type, the exemplary embodiment of the present invention is not limited thereto.

FIG. 6 illustrates a longitudinal sectional view of the area A of the portable display apparatus 100 of FIG. 5. The portable display apparatus 100 includes a liquid crystal display 10, 10′, or 20 which is one of the liquid crystal displays 10, 10′, or 20 as described above with reference to FIGS. 1a and 1b. The liquid crystal display 10, 10′, or 20 includes a transparent film 110, a buffer layer 120, a liquid crystal panel (130 of FIGS. 1a and 2), and a backlight unit 140.

The portable display apparatus 100 includes a plurality of frames, including first, second, and third frames 102, 117, and 116 for mounting and supporting the liquid crystal display 10, 10′, or 20, and a case 122 for housing the frames 102, 117, and 116. The liquid crystal display 10, 10′, or 20, and constitutional elements thereof are as described above, and thus, a detailed description thereof will be omitted. Hereinafter, the process of mounting the liquid crystal display 10, 10′, or 20 in the case 122 using the frames 102, 117, and 116 to complete the portable display apparatus 100 will be described.

The first frame 102 contains the liquid crystal display 10, 10′, or 20, the second frame 117, and the third frame 116. In more detail, the backlight unit 140 including an optical sheet 141, a light guide plate 142, a light source 143, and a reflective sheet 144 is first contained in the first frame 102. The second frame 117 is contained in the first frame 102 to fixedly hold the backlight unit 140 including the optical sheet 141, the light guide plate 142, the light source 143, and the reflective sheet 144. The second frame 117 has an opening at its center portion, and the optical sheet 141 is positioned in the opening. The opening allows light emitted from the light source 143 to pass therethrough. Meanwhile, the liquid crystal display 10, 10′, or 20 is disposed on the second frame 117. The transparent film 110 is disposed on a second polarization plate 135. The transparent film 110 may be composed of only a polymer film as shown in FIGS. 1a and 1b, or may be composed of a polymer film (see 111 of FIG. 2) and a hard coating layer (see 112 of FIG. 2) as shown in FIG. 2. The transparent film 110 is adhered to the second polarization plate 135 disposed on a second plate 133 of the liquid crystal panel 130 via the buffer layer 120 having an adhesive characteristic. Meanwhile, the third frame 116 fixedly holds the liquid crystal display 10, 10′, or 20.

The resultant structure in which the liquid crystal display 10, 10′, or 20, the second frame 117, and the third frame 116 are contained in the first frame 102 is housed by a first case 122a having at the central portion a window exposing an image display surface of the liquid crystal display 10, 10′, or 20, and a second case 122b.

Meanwhile, portions of the first and third frames 102 and 116 exposed through the window of the first case 122a are covered with a protection case 119. Here, an area intended for placement of the protection case 119 corresponds to an area to which a conventional protection window for protecting the liquid crystal display is attached by two-sided tape. However, since no protection window is used in the portable display apparatus 100 of this exemplary embodiment, the protection case 119 protects the portions of the first frame 102 and the third frame 116 exposed through the window of the first case 122a. Meanwhile, the protection case 119 may be integrally formed with the first case 122a.

As described above, in the portable display apparatus 100 of this exemplary embodiment, the liquid crystal panel 10, 10′, or 20 is protected by attaching the transparent film 110, which is lightweight and resistant to an external shock, to the liquid crystal panel 10, 10′, or 20 by means of the buffer layer 120 having an adhesive function. Therefore, the portable display apparatus 100 of the present exemplary embodiment doesn't need the protection window and the space between the protection window and the liquid crystal display which the conventional portable display apparatus has. Therefore, the portable display apparatus 100 of the present exemplary embodiment is thinner(about 30%) and lighter than conventional portable display apparatus.

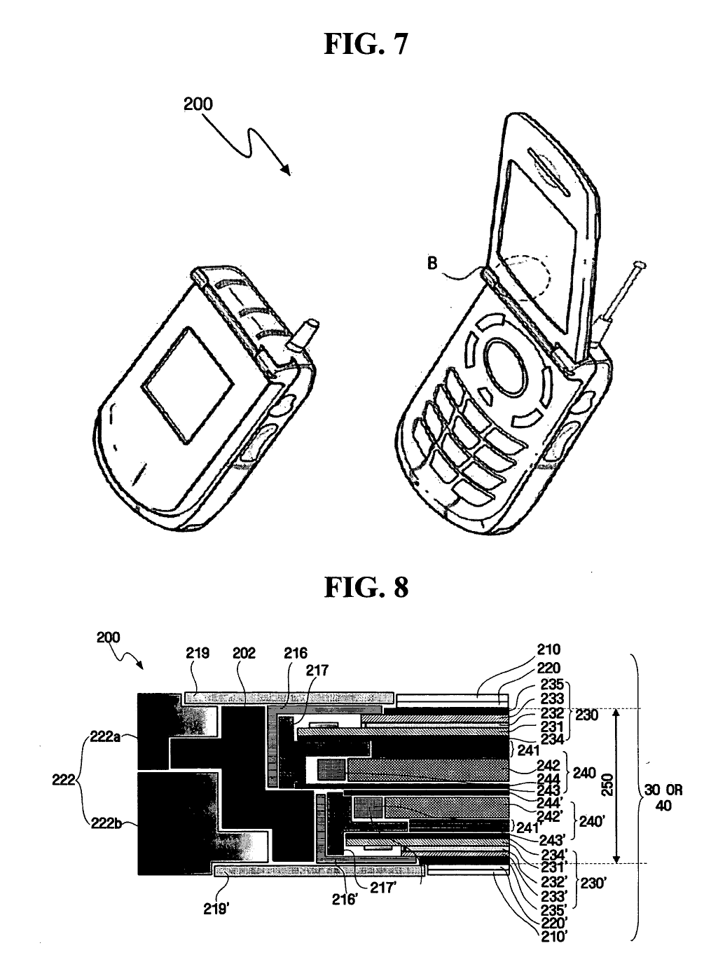

FIG. 7 is a perspective view of a portable display apparatus according to another embodiment of the present invention and FIG. 8 is a longitudinal sectional view of a portion B of FIG. 7.

Referring to FIG. 7, a portable display apparatus 200 is a folder-type portable display apparatus. The left view of FIG. 8 illustrates a state in which the folder-type portable display apparatus 200 is closed and the right view of FIG. 8 illustrates a state in which the folder-type portable display apparatus 200 is open. Although the portable display apparatus 200 is illustrated as a folder type, this exemplary embodiment of the present invention is not limited thereto. The portable display apparatus 200 includes two liquid crystal panels as shown in FIG. 8.

FIG. 8 is a longitudinal sectional view of the area B of the portable display apparatus 200 of FIG. 7. The portable display apparatus 200 includes a liquid crystal display 30 or 40 which is one of the liquid crystal displays 30 and 40 shown in FIGS. 3 and 4. The liquid crystal display 30 or 40 includes the first liquid crystal panel 230 and the second liquid crystal panel 230′. Transparent films 210 and 210′ are respectively disposed on second polarization plates 235 and 235′ which are respectively disposed on the surfaces of the second plate 233 of the first liquid crystal panel 230 and the second plate 233′ of the second liquid crystal panel 230′. The other constitutional elements of the portable display apparatus of this exemplary embodiment are as described above, and thus, a detailed description thereof will be omitted.

The portable display apparatus 200 includes a plurality of frames including a first frame 202, second frames 217 and 217′, and third frames 216 and 216′ for mounting and supporting the liquid crystal display 30 or 40, and a case 222 for housing the frames 202, 217, 217′, 216, and 216′. Here, the frames 202, 217, 217′, 216, and 216′ for mounting and supporting the liquid crystal display 30 or 40 and the case 222 for housing the frames 202, 217, 217′, 216, and 216′ are substantially the same as the frames 102, 117, and 116, and the case 122 of the portable display apparatus 100 of the exemplary embodiment shown in FIG. 6, and thus a detailed description thereof will be omitted.

The first frame 202 serves to contain, support, and fixedly hold the first liquid crystal panel 230 and a first backlight unit 240, and at the same time, to fixedly hold the second liquid crystal panel 230′ and a second backlight unit 240′. A first case 222a and a second case 222b have windows at their areas corresponding to image display surfaces of the first liquid crystal panel 230 and the second liquid crystal panel 230′. Portions of the frames 202, 216, and 216′ exposed through the windows of the first and second cases 222a and 222b are covered and protected with protection cases 219 and 219′. These protection cases 219 and 219′ may be integrally formed with the first and second cases 222a and 222b.

Similarly to the above description, in the above-described portable display apparatus 200, the transparent films 210 and 210′ are respectively disposed on the second polarization plates 235 and 235′ of the first and second liquid crystal panels 230 and 230′. A detailed description thereof is as given above and thus will be omitted.

As described above, in the portable display apparatus 200 of this exemplary embodiment, the liquid crystal panels 230 and 230′ are protected by attaching the transparent films 210 and 210′, which are lightweight and resistant to an external shock, to the liquid crystal panels 230 and 230′ by means of buffer layers 220 and 220′ having an adhesive function. Therefore, the portable display apparatus 200 of present exemplary embodiment doesn't need the protection window and the space between the protection windows and the liquid crystal display which the conventional portable display apparatus has. Therefore, the portable display apparatus 200 of the present exemplary embodiment is thinner and lighter than the conventional portable display apparatus.

Further, as noted, the liquid crystal display of the exemplary embodiments of the present invention provides at least the following desirable features described below.

First, in the liquid crystal display and the portable display apparatus according to the exemplary embodiments of the present invention, provide a transparent film including a polymer film or both a polymer film and a hard coating layer attached to a liquid crystal panel by means of an buffer layer having an adhesive function.

Second, the liquid crystal panel is protected from external scratches or shocks by the transparent film and the buffer layer, and the thickness and weight of the portable display apparatus including the liquid crystal panel is reduced in comparison to conventional portable display apparatuses.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A liquid crystal display comprising:
a liquid crystal panel comprising a first plate, a second plate facing the first plate, and a liquid crystal layer interposed between the first plate and the second plate;
a transparent film disposed on an upper surface of the second plate; and
a buffer layer interposed between the transparent film and the second plate.

2. The liquid crystal display of claim 1, wherein the buffer layer has an adhesive characteristic.

3. The liquid crystal display of claim 1, wherein the buffer layer has a light transmittance of at least about 60%.

4. The liquid crystal display of claim 1, wherein the buffer layer comprises a material selected from the group consisting of a silicone resin and an acrylic resin.

5. The liquid crystal display of claim 1, wherein the transparent film comprises a polymer film having a light transmittance of at least about 60%.

6. The liquid crystal display of claim 5, wherein the polymer film comprises a material selected from the group consisting of polyethyleneterephthalate, polycarbonate and polymethylmethacrylate.

7. The liquid crystal display of claim 5, wherein the transparent film further comprises a hard coating layer disposed on the polymer film.

8. The liquid crystal display of claim 7, wherein the hard coating layer comprises a photoresist resin.

9. The liquid crystal display of claim 1, wherein the buffer layer includes at least two layers having different characteristics.

10. The liquid display device of claim 9, wherein the buffer layer includes a first adhesive layer adhering to the transparent film, a second adhesive layer adhering to the liquid crystal panel, and a cushion layer interposed between the first adhesive layer and the second adhesive layer.

11. A liquid crystal display comprising:
a liquid crystal panel module comprising first and second liquid crystal panels each having a first plate, a second plate and a liquid crystal layer interposed between the first plate and the second plate, the first plates of the first and second liquid crystal panels being opposite to each other,
a transparent films disposed on upper surfaces of the second plates of the first and second liquid crystal panels of the liquid crystal panel module; and
a buffer layers interposed between the transparent films and the second plates of the first and second liquid crystal panels.

12. The liquid crystal display of claim 11, wherein the buffer layer has an adhesive characteristic.

13. The liquid crystal display of claim 11, wherein the buffer layer has a light transmittance of at least about 60%.

14. The liquid crystal display of claim 11, wherein the buffer layer includes at least two layers having different characteristics.

15. The liquid display device of claim 14, wherein the buffer layer includes a first adhesive layer adhering to the transparent film, a second adhesive layer adhering to the liquid crystal panel, and a cushion layer interposed between the first adhesive layer and the second adhesive layer.

16. A portable display apparatus comprising:
a liquid crystal display comprising a liquid crystal panel having a first plate, a second plate disposed on the first plate, a liquid crystal layer interposed between the first plate and the second plate, a transparent film disposed on an upper surface of the second plate and protecting the liquid crystal panel; and
a buffer layer interposed between the transparent film and the second plate;
a frame for mounting and supporting the liquid crystal display; and
a case for housing the frame.

17. The portable display apparatus of claim 16, wherein the buffer layer has an adhesive characteristic.

18. The portable display apparatus of claim 16, wherein the buffer layer has a light transmittance of at least about 60%.

19. The portable display apparatus of claim 16, wherein the buffer layer includes at least two layers having different characteristics.

20. The portable display apparatus of claim 19, wherein the buffer layer includes a first adhesive layer adhering to the transparent film, a second adhesive layer adhering to the liquid crystal panel, and a cushion layer interposed between the first adhesive layer and the second adhesive layer.

21. A portable display apparatus comprising:
a liquid crystal display comprising a liquid crystal panel module having first and second liquid crystal panels each having a first plate, a second plate, a liquid crystal layer interposed between the first plate and the second plate, the first plates of the first and second liquid crystal panels being opposite to each other, a transparent films disposed on upper surfaces of the second plates of the first and second liquid crystal panels of the liquid crystal panel module and protecting the first and second liquid crystal panels, and a buffer layers interposed between the transparent films and the second plates of the first and second liquid crystal panels;
a frame for mounting and supporting the liquid crystal display; and
a case for housing the frame.

22. The portable display apparatus of claim 21, wherein the buffer layer has an adhesive characteristic.

23. The portable display apparatus of claim 21, wherein the buffer layer has a light transmittance of at least about 60%.

24. The portable display apparatus of claim 21, wherein the buffer layer includes at least two layers having different characteristics.

25. The portable display apparatus of claim 24, wherein the buffer layer includes a first adhesive layer adhering to the transparent film, a second adhesive layer adhering to the display panel, and a cushion layer interposed between the first adhesive layer and the second adhesive layer.

26. A display device comprising:
a display panel;
a transparent film disposed on the display panel; and
a buffer layer interposed between the transparent film and the display panel.

27. A display device comprising:
a display panel;
a transparent film disposed on the display panel; and
a buffer layer interposed between the transparent film and the display panel,
wherein the buffer layer has an adhesive characteristic and a light transmittance of at least about 60%.

28. A display device comprising:
a display panel;
a transparent film disposed on the display panel; and
a buffer layer interposed between the transparent film and the display panel,
wherein the buffer layer includes at least two layers having different characteristics.

29. The display device of claim 28, wherein the buffer layer includes a first adhesive layer adhering to the transparent film, a second adhesive layer adhering to the display panel, and a cushion layer interposed between the first adhesive layer and the second adhesive layer.
